(19) United States
(12) Patent Application Publication
(10) Pub. No.: US 2002/0193159 A1
(43) Pub. Date: Dec. 19, 2002

(54) Game system utilizing internet

(76) Inventor: Takashi Maejima, Ishioka city (JP)

Correspondence Address: ARMSTRONG,WESTERMAN & HATTORI, LLP, 1725 K STREET, NW., SUITE 1000, WASHINGTON, DC, 20006, US

(21) Appl. No.: 09/948,967

(22) Filed: Sep. 10, 2001

(30) Foreign Application Priority Data
Apr. 5, 2000 (JP) 2000-103211

(51) Int. Cl. A63F 13/00

(52) U.S. Cl. 463/20; 463/7; 463/42; 273/138.1; 273/138.3; 273/139

(57) ABSTRACT

The present invention relates to a game system utilizing the Internet capable of enjoying in real time a pinball game on a game machine installed in a pinball parlor under a remote operation by the utilization of the Internet.

The present invention constitutes a game system utilizing the Internet comprising a terminal equipment, at least one camera and game machine, a server for controlling a remote device incorporating a camera, a light and a processor, and a card reader.

### DETAILED DESCRIPTION OF THE INVENTION

1. Field of Industrial Utilization

The present invention relates to a game system in which the Internet and a high speed communication system are utilized so that even a person in a location remote from a pinball parlor can enjoy in real time a pinball or a pinball slot installed in the pinball parlor.

2. Prior Art

Generally, in a case where a game player plays a game such as a pinball or a pinball slot, the player must go to a pinball parlor built in a specific place where a pinball machine, a pinball slot machine or the like is installed, to play a game such as the pinball and the pinball slot.

Moreover, when the player plays a game such as the pinball or the pinball slot on the pinball machine or the pinball slot machine installed in the pinball parlor, the player has selected the game machine by checking how nails are arranged, how balls are discharged, and how balls flow in the pinball machine or the pinball slot machine installed in the pinball parlor.

Currently, when the player plays a game such as pinball and the pinball slot in the pinball parlor, the player purchases balls for cash or by a prepaid card, purchases coins for cash or by the prepaid card, and then plays the game.

Moreover, when the player cashes balls or coins, the player has changed the balls or coins for a cash claimable article at a counter installed in the pinball parlor, and cashed said cash claimable article.

### Problems to be Solved by the Invention

However, as described in the above, in order to play a game such as a pinball or a pinball slot, it is necessary to go to a pinball parlor, a pinball slot parlor or the like. A person having difficulty in walking such as a physically handicapped person or an old person uses a wheelchair or has a trouble in the leg, and hence it is extremely difficult to go to a game house such as the pinball parlor and the pinball slot parlor. In consequence, it is actually unable for such a person to enjoy a game such as the pinball and pinball slot.

Moreover, the physically handicapped person, the old person or the like is forced to enjoy the game within a limited time, and inconveniently, the person cannot enjoy a game such as the pinball and the pinball slot for a long time.

Furthermore, when a player cashes balls for the pinball machine and coins for the pinball slot machine, the player must exchange the balls and the coins for a cash claimable article at the gift counter of the pinball parlor, and then cash the cash claimable article at a realization place. This inconveniently takes a great deal of time for payment.

Therefore, an object of the present invention is to construct a game system utilizing the Internet and a high communication system in which, for playing a game such as the pinball and the pinball slot, even a person having difficulty in going to the pinball parlor such as a physically handicapped person or an old person can enjoy a game such as the pinball or the pinball slot at home only if such a person owns a terminal equipment to be connected to the pinball parlor, and further, can enjoy a game such as the pinball and the pinball slot freely at any time, and a settlement system such as a card is employed which can save the trouble of cashing and the like.

### Means for Solving the Problem

The present invention provides a game system utilizing the Internet comprising a terminal equipment, at least one camera and game machine, a server for controlling a remote device incorporating the camera, a light and a processor, and a card reader.

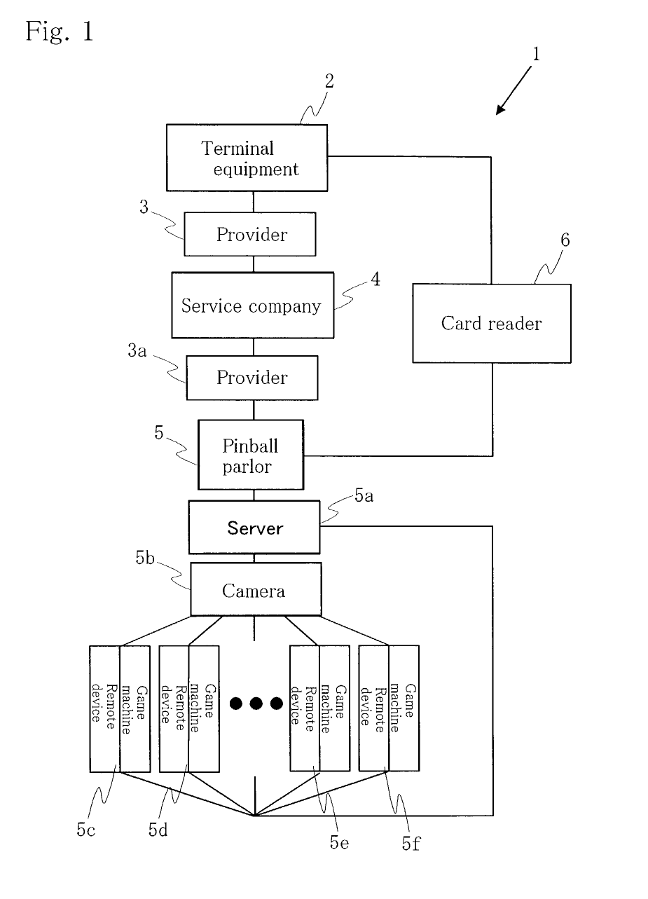

### BRIEF DESCRIPTION OF THE DRAWINGS

[FIG. 1]

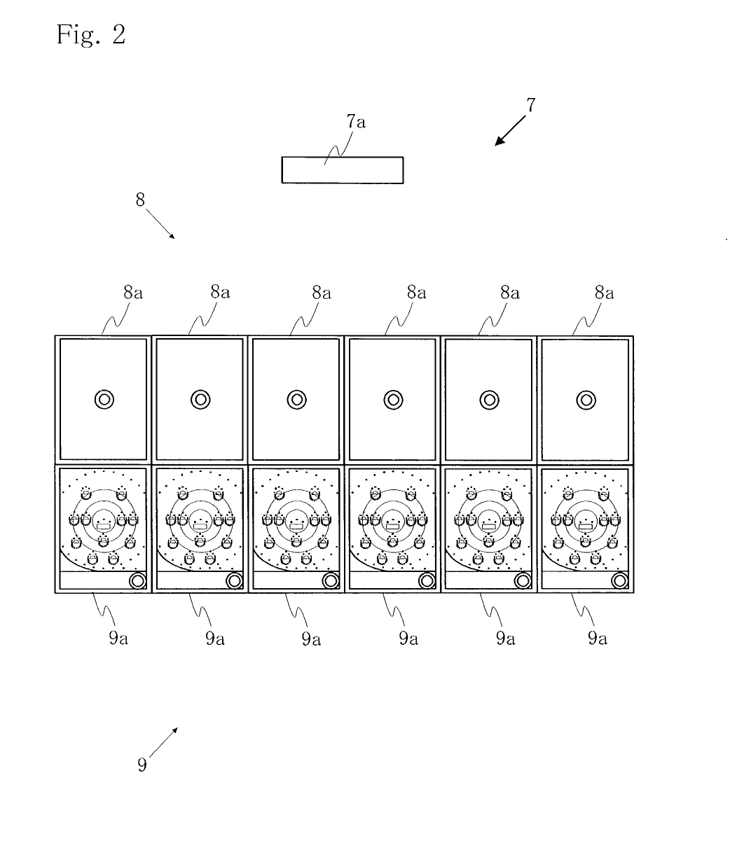

A whole view of a pinball system utilizing a communication circuit of the present invention.

[FIG. 2]

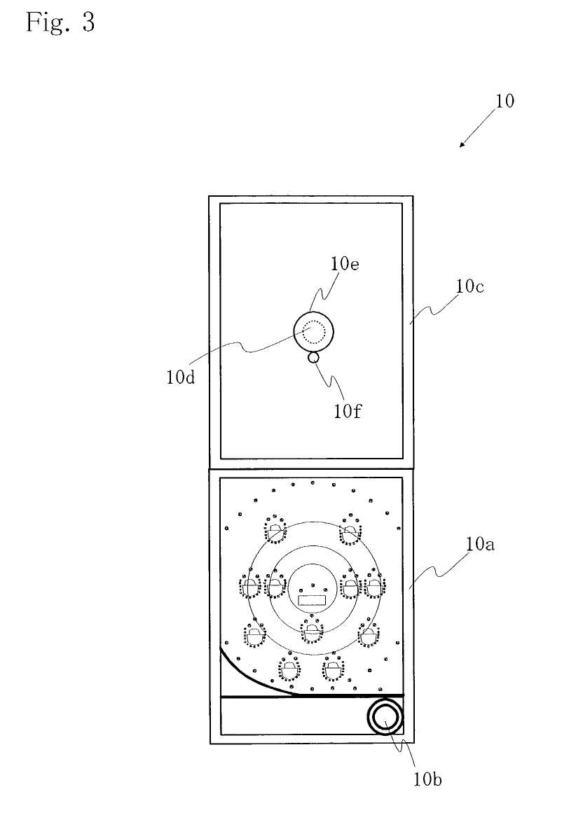

A block diagram of the inside of a pinball parlor in which a pinball system utilizing a communication circuit according to the present invention is installed.

[FIG. 3]

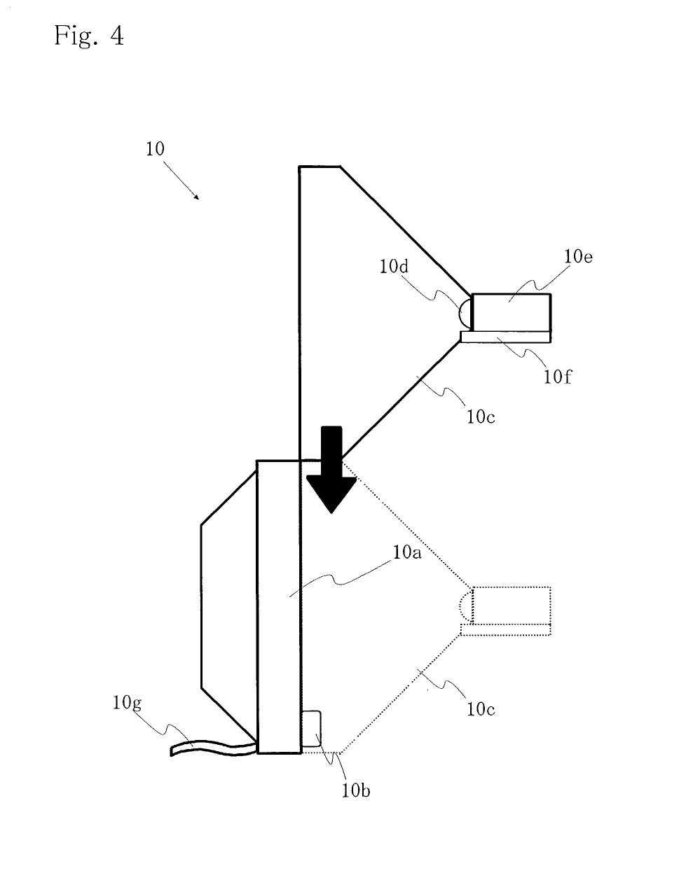

An enlarged view of a pinball machine of FIG. 2.

[FIG. 4]

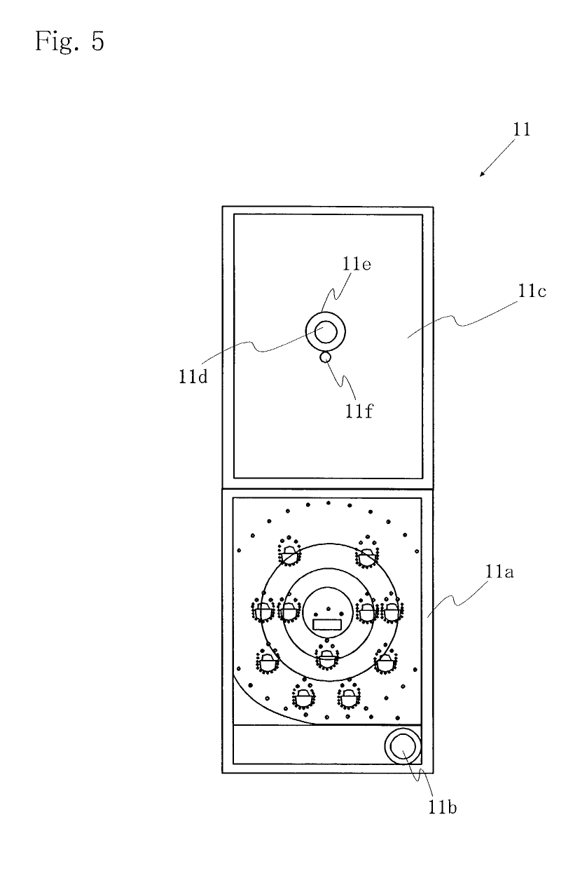

A structural view of the pinball machine.

[FIG. 5]

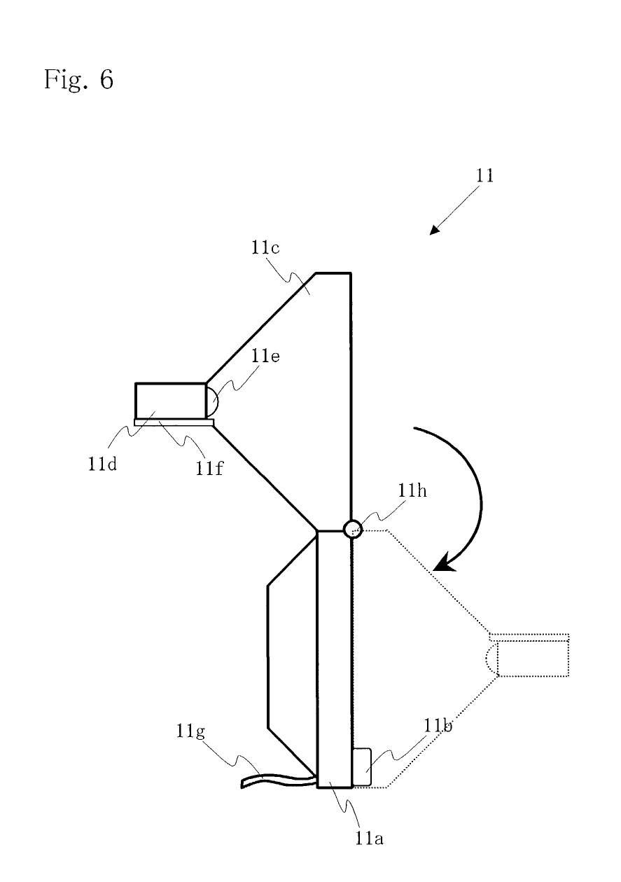

An enlarged view of a pinball machine of other embodiment.

[FIG. 6]

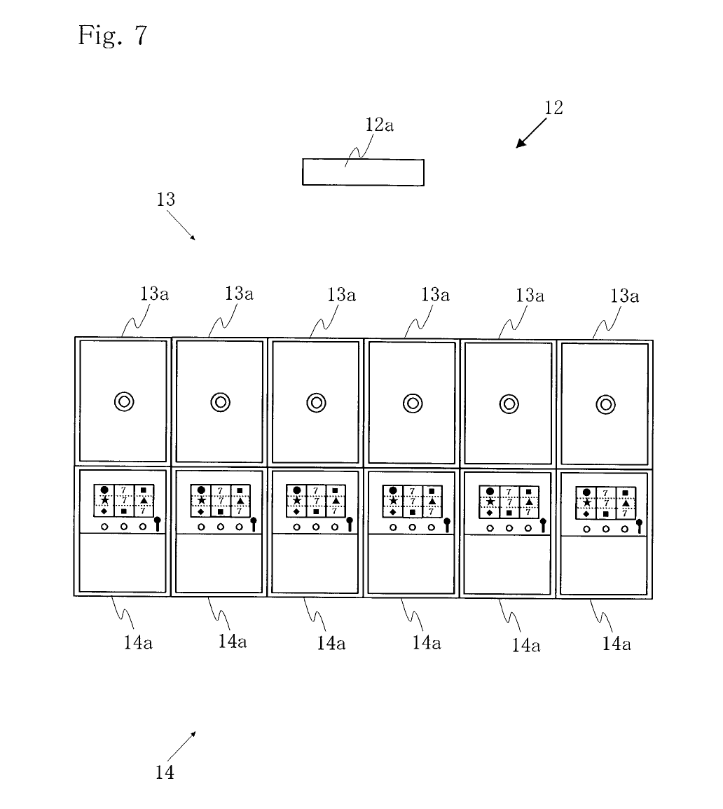

A structural view of a pinball machine of other embodiment.

[FIG. 7]

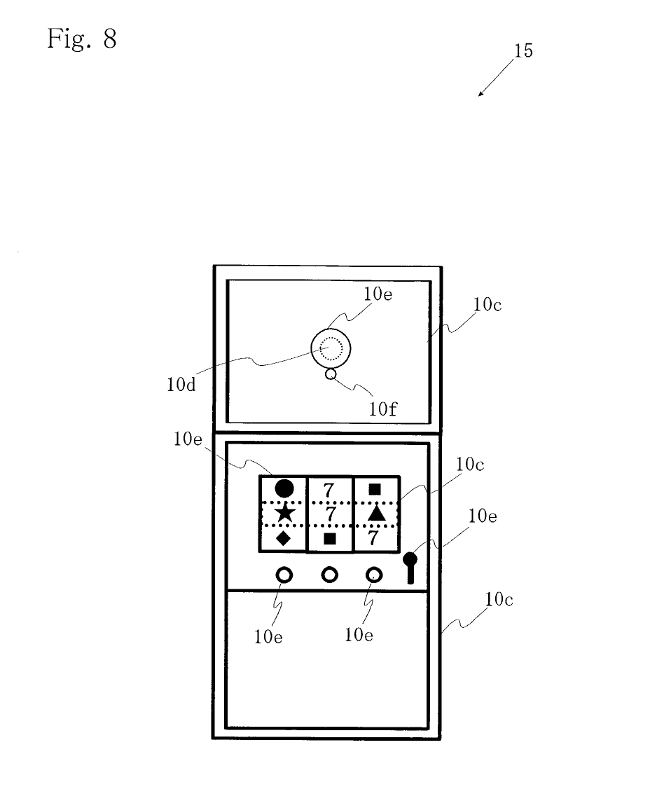

A structural view of the inside of a pinball parlor which the pinball system utilizing the communication circuit according to the present invention is installed.

[FIG. 8]

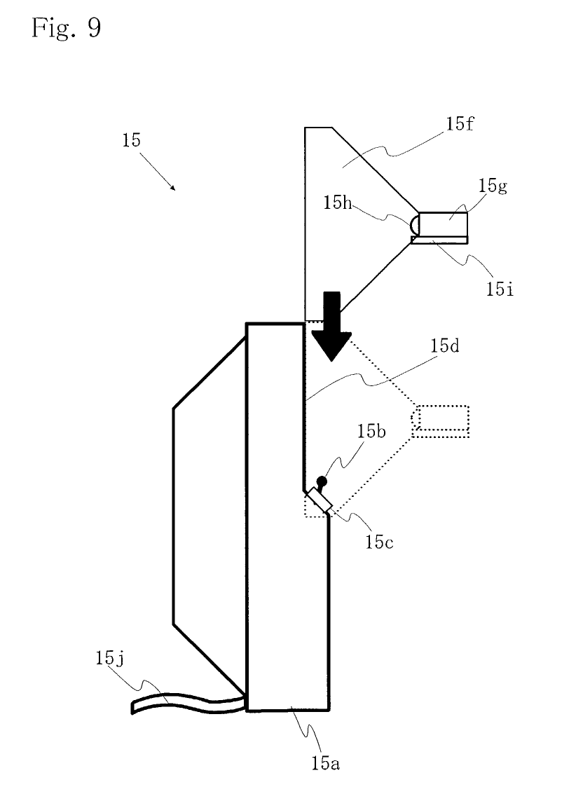

An enlarged view of the pinball machine of FIG. 7.

[FIG. 9]

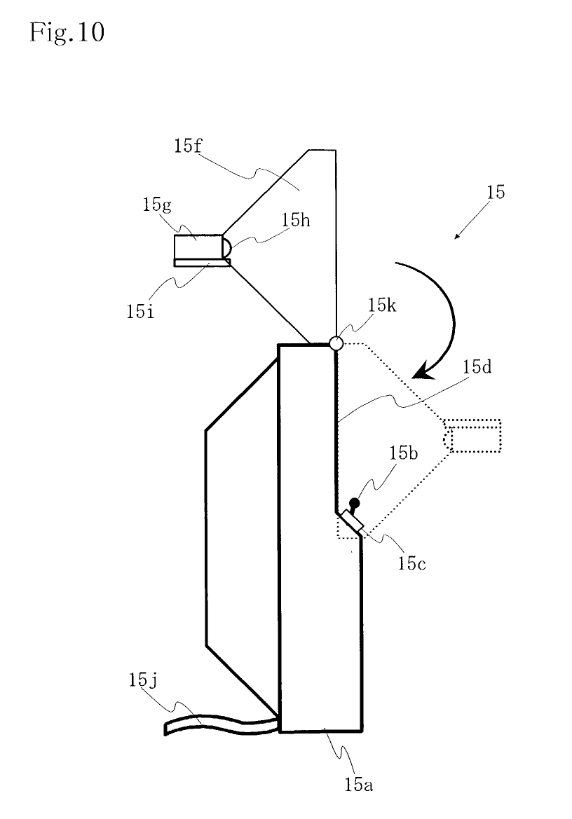

A structural view of a pinball machine.

[FIG. 10]

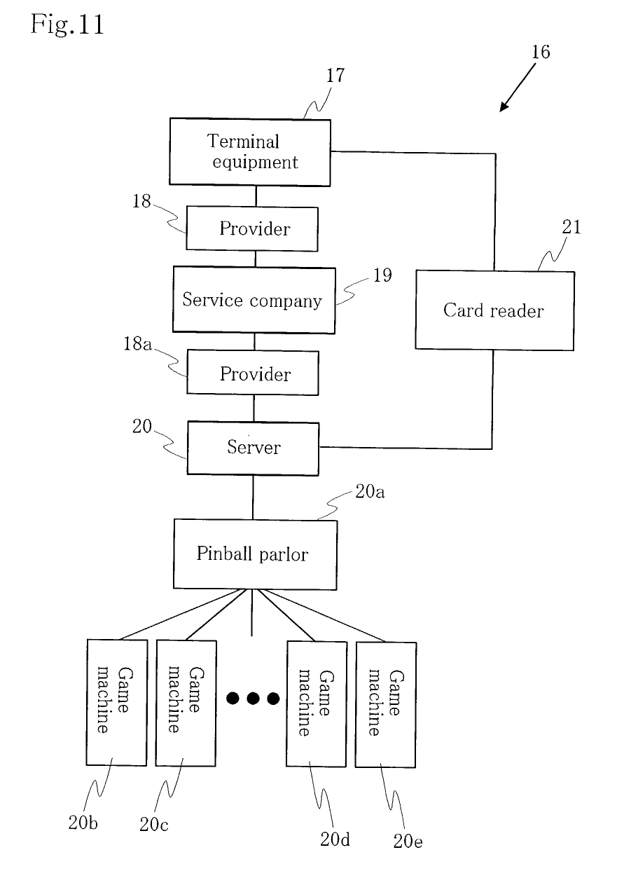

A structural view of a pinball machine of other embodiment.

[FIG. 11]

A system diagram of other embodiment of the game stem utilizing the communication circuit according to the present invention.

### EMBODIMENTS

Now, referring to the accompanying drawings, a game system utilizing the Internet according to the present invention will be described in detail. In FIG. 1, the whole view of the game system utilizing the Internet which is the present invention is shown.

In a game system 1 according to the present invention, as shown in FIG. 1, a terminal equipment 2 of a user (a game player) is connected to a pinball parlor 5 by the utilization of the Internet or a high speed communication system via a provider 3, a service company 4 and the like.

After connecting to the pinball parlor 5, a game machine is selected from game machines 5c to 5f each having a remote device installed in the pinball parlor 5, and a projected image and a sound field of the selected game machine are transmitted in real time to the terminal equipment 2 of the user by using a light, a camera and a processor for optimizing the image and the sound which are provided in the remote device, thereby enabling the user to enjoy the game in the same way as if playing it in the pinball parlor.

A provider 3a and the service company 4 may be used or may not be used, depending on the Internet or the high speed communication system to be used.

Moreover, all balls for the pinball game are purchased and cashed by a prepaid card (a prepaid payment system) or a card (a later payment system after settlement interlocked with a passbook) tied up with the pinball parlor.

In using the prepaid card described above and the card tied up with the pinball parlor, it is necessary to connect an exclusive settlement card reader 6 to the terminal equipment 2 installed at home.

Next, a method of using the game system will be described in detail using FIG. 1. As shown in FIG. 1, a user who utilizes the game system 1 utilizing the Internet according to the present invention connects the terminal 2 previously connected with the exclusive settlement card reader 6, to the pinball parlor 5 via the provider 3 and the service company 4.

As a prerequisite to connect and utilize this game system 1 utilizing the Internet, the user concludes a connection and utilization contract with the pinball parlor 5 or the service company 4, gets a PIN code, an ID number, a password and the like issued from said service company 4 or the pinball parlor, and then input the PIN code, the password and the like, whereby the user can connect to and enter the pinball parlor 5.

Moreover, in the pinball parlor 5 is installed a server 5a, and a game machine desired to be played is selected from the game machines 5c to 5f provided with the remote devices through a monitor camera 5b connected to the server 5a, and a game such as the pinball or the pinball slot is started.

The server 5a controls in real time the monitor camera 5b installed in a pinball parlor 7 and the game machines 5c to 6f provided with the remote devices provided in the pinball parlor 5.

When a machine for playing a game such as the pinball or the pinball slot is selected from the game machines 5C to 5f, the remaining count within which a game such as the pinball or the pinball slot can be played is displayed on a screen by the settlement card reader 6. Accordingly, a game such as the pinball or the pinball slot can be enjoyed, until such a count is consumed.

When the game is started, an image and a sound of the machine selected from the game machines 5C to 5f are transmitted to the terminal equipment 2 of the user in real time by the use of a light, a camera and a processor for optimizing the image and the sound disposed on each of remote devices 8a, 8a, 8a . . . of pinball game machines 9a, 9a . . . provided on the game machines 5c to 5f, whereby the game can be enjoyed as in the pinball parlor.

Moreover, a counter is provided in the image on the game machine transmitted from the pinball parlor, and the number of balls for the pinball can be known by the counter.

By an exclusive settlement card reader 6 connected to the terminal equipment 2, if the card is an exclusive prepaid card, the remaining count is displayed on the screen. When the remaining count has been consumed, the game is over. In the case of a tied up card, an upper limit is set in advance, and the game can be enjoyed within a range of the upper limit.

When the game is over and the gotten balls are to be cashed, a settlement is made by saving the number of the balls in the exclusive prepaid card or the tied up card. At this time, if it is desired to exchange the balls for a gift, the exchange can be made by selecting the gift on the screen, and the selected gift can be delivered by a home delivery service or the like.

Moreover, it is also possible to reserve the balls on hand, depending on the pinball parlor. Furthermore, when the game machine is changed, another game machine can simply be selected again.

As described above, the game system utilizing a communication circuit according to the present invention comprises a server for controlling a terminal equipment, at least one camera, a game machine and a remote device, and a card reader.

FIG. 2 is a block diagram of the inside of the pinball parlor where the game system utilizing the Internet according to the present invention is installed. FIG. 3 is an enlarged view of a pinball machine shown in FIG. 2, and FIG. 4 is a block diagram of the pinball machine.

As shown in FIG. 2, in the pinball parlor 7, the remote device 8a is provided on the usual game machine 9a (hereinafter referred to as “a pinball machine 10”), and at the upper part in the parlor, a monitor camera 7a for monitoring a certain number of the game machines 9 and the remote devices 8 is provided.

In the case that a number of game machines 9a, 9a, 9a . . . are installed, the monitor camera 7a shown in FIG. 2 can display, in real time on the terminal equipment of the user, a use situation that any game machines 9a, 9a, 9a . . . are not used, in accordance with the request of the user.

The pinball machine 10, as shown in FIG. 3, comprises a game machine 10a having an image of a handle 10b for adjusting the hitting of balls, a tray, nails, a guide and the like, and a remote device 10c provided with a processor 10e for optimizing a sound, a light 10F, and a camera 10d.

As described in the above, the remote device 10c is constituted of the processor 10e for optimizing the image and the sound, the light 10f, and the camera 10d. The game machine 10a projected by said light 10f and the camera 10d is enlarged, scaled down, and adjusted by an image device.

The sound field is adjusted by the sound device 10e, and the projected image and the sound are transmitted by using the Internet and the high speed communication system. Moreover, in order to check the adjustment of nails and the like by the image device, it is also possible to enlarge a portion of the game machine 10a.

When playing the pinball, in case a pinball remote device of FIG. 3 is seen from the left side, as shown in FIG. 4, the remote device 10c is slid downward to the game machine 10a provided in the lower part, and finally, and the screen will be covered.

The game machine 10a inside the pinball machine 10 in the state of FIG. 4 is carried out without a change from a normal operation, by the processor 10e for optimizing the image and the sound field provided in the remote device 10c, light 10f and camera 10d, the projected image and the sound of field of an operation of the pinball are transmitted in real time to the terminal equipment of the user, while the user is enlarging and scaling down said projected image for easy viewing, it is possible to enjoy the game in the same way as playing in the pinball parlor.

FIG. 5 is an enlarged view of the pinball machine of other embodiments installed in the pinball parlor, and FIG. 6 is a block diagram of the pinball machine of other embodiments.

A pinball machine 11, as shown in FIG. 5, comprises a game machine 11a provided with a handle 11b for adjusting the hitting of balls, and a remote device 11c provided with a processor 11e for optimizing the image and the sound field provided in the upper part of a game machine 11a, and a remote device 11c provided with a processor 11e for optimizing the image and the sound field installed on the game machine 11a, light 11f, and camera 11d.

When playing the pinball, as shown in the block diagram of the pinball remote device of FIG. 6, the remote device 11c provided with the processor 11e for optimizing the image and the sound field, light 11f, and camera 11d makes a half-turn on the game machine 11a by a rotating member 11f provided between the remote device 11c and the game machine 11a, and finally, the screen of the game machine 11a provided in the lower part of the remote device 11c will be covered.

The game machine 11a inside the pinball machine 11 in the state of FIG. 6 is carried out without a change from the normal operation, in the same manner as FIG. 4, by the image device, the sound field device, the light and the camera 11d provided in the remote device 11c, the projected image and the sound field of the operation of the pinball are transmitted in real time to the terminal equipment of the user, while the user is enlarging and scaling down said projected image for easy viewing, it is possible to enjoy in the same manner as playing in the pinball parlor.

FIG. 7 is a block diagram of the inside of the pinball parlor in which a pinball system utilizing the communication circuit according to the present invention is installed, FIG. 8 is an enlarged view of the pinball machine of FIG. 7, FIG. 9 is a block diagram of the pinball machine, and FIG. 10 is a block diagram of the pinball machine of other embodiment.

As shown in FIG. 7, in the pinball slot parlor 12, the remote device 13a is provided on the usual game machine 14a (hereinafter referred to as “a pinball machine 15”), and in the upper part in the parlor, a monitor camera 12a for monitoring a certain number of game machines 14 and remote devices 13 is provided.

The monitor camera 12a shown in FIG. 7 can display, in real time on the terminal equipment of the user, a use situation that any game machines 14a . . . are not used, in accordance with the demand of the user.

The pinball machine 15, as shown in FIG. 8, comprises a game machine 15a and a remote device 15f provided on the game machine 15a.

The game machine 15a comprises a screen 15d in which reels 15e, 15e and 15e turning longitudinally in left, center and right directions are stored, buttons 15c, 15c and 15c for stopping a pattern provided in said reels 15e, 15e and 15e, and a slot lever 15b for starting rotation of said reels 15e, 15e and 15e.

The remote device 15f comprises a processor 15g for optimizing the image and the sound, a light 15i and a camera 15h.

As described above, the remote device 15f is provided with the processor 15a, camera 15i and camera 15h, the screen 15d of the game machine 15a projected by the light 15i and the camera 15h is enlarged, scaled down, and adjusted of the image and adjusted of the sound field of the sound, and the projected image and the sound field are transmitted by using the Internet and the high speed communication system.

When playing the pinball, in case the pinball remote device of FIG. 8 is seen from the left side, the game machine 15a is slid downward to the game machine 15a provided in the lower part, and finally, the screen will be covered.

The game machine 15a inside the pinball machine 15 with the game machine 15a of FIG. 9 being covered is carried out without a change from the ordinary operation, by the processor 15g, light 15i and camera 15h provided in the remote device 15f, the projected image and the sound field of the operation of the pinball are transmitted in real time to the terminal equipment of the user, while the user is enlarging and scaling down said projected image for easy viewing, it is possible to enjoy in the same manner as playing the game in the pinball parlor.

As shown in FIG. 10, in the pinball machine of other embodiment, as compared to the remote device 15f of the pinball machine of FIG. 9 which was slid downward, the remote device 15f makes a half-turn downward.

The game machines 15a inside the pinball machine 15 of other embodiment shown in FIG. 10 is also carried out without a change from the ordinary operation, as shown in FIG. 9, by the processor 15g, light 15i and camera 15h provided in the remote device 15f, the projected image and the sound field of the operation of the pinball are transmitted in real time to the terminal equipment of the user, while the user is enlarging and scaling down said projected image for easy viewing, it is possible to enjoy in the same manner as playing in the pinball parlor.

In FIG. 11 is shown a system diagram of other embodiment of the game system utilizing the Internet according to the present invention.

As shown in FIG. 11, a game system for playing games utilizing the communication circuit 16 which is the present invention comprises a terminal equipment 17 comprising at least one terminal equipment, providers 18 and 18a, a service company 19, a server 20 provided in a pinball parlor 20a and a pinball parlor 20a, game machines 20b˜20e and a card reader 21, by utilizing the server 20 provided in the terminal equipment 17a nd the pinball parlor 20a, and the Internet or the high speed communication system.

The provider and the service company may or may not use the Internet or the high speed communication system and the like to be used.

As the game machine, there are the pinball game machine 10a shown in FIG. 3 and the pinball game machine 15a shown in FIG. 8.

Said system is a system for playing games in which the user uses the terminal equipment 17, utilizes the Internet or high speed communication via providers 18 and 18a and the service company 19 and the like, connects to the pinball parlor 20a, selects a machine desired to be played from game machines 20b to 20e provided in the pinball parlor 20a

Moreover, all settlements are carried out by the prepaid card (a payment in advance system) or the tied up card (a pay later system after settlement interlocked with a passbook).

When using the prepaid card or the tied up card, it is necessary to connect an exclusive settlement card reader 21 to the terminal equipment 2 installed at home.

Moreover, the game machines 20b˜20e provided in the pinball parlor 20a shown in the above, in which pinball or pinball game programs are incorporated in all game machines, are driven by said game programs.

As a result, the screen of the game machines 20b˜20e, in which a winning opening for feeding and receiving balls, and nails and the like for guiding balls are not installed unevenly as conventional pinball game machines, is a graphic screen where all balls, nails, winning opening and the like are shown graphically, and the projected image is projected on the screen of the game machine by said game program.

All the game machines 20b to 20e on the graphic screen provided in the pinball parlor are controlled by the server.

When playing games with said game system, as in the past, there is a way to go directly to the pinball parlor and playing games, and a way to play games by using the Internet or the high speed communication system from the terminal equipment 17 (a personal computer, television and the like having a personal computer function) installed at home.

When the game is played on the terminal equipment at home which is the latter, as shown in FIG. 11, the user connects the terminal equipment 17 previously connected with an exclusive settlement card reader 21, to the server 20 of the pinball parlor 20a via the providers 18, 18a and the service company 19.

After the above connection has been made, a password number is issued from the pinball parlor 20a and then inputted, whereby entry into the pinball parlor 20a is made possible.

In the pinball parlor 20a, the server 20 is installed, and in this server 20, the game machines 20b to 20e of the pinball parlor 20a are controlled. In the pinball parlor 20a, a monitor camera is installed, by which a machine desired to be played is selected from the game machines 20b to 20e.

As described above, the server 20 controls in real time the monitor camera and the game machines 20b to 20e disposed in the pinball parlor 20a, balls discharge adjustment, and the like.

When the game machines 20b to 20e are selected, a program of said game machines 20b to 20e is transmitted to the terminal equipment 17 of the user by the server 20, the same program as that of the game machines 20b to 20e of the pinball parlor 20a is activated by said program, projected on the terminal equipment 17 of the user, enabling to play games.

Moreover, at a time the game machines 20b to 20e to be played are selected, the balance enabling the game is displayed on the screen by the settlement card reader 21. The game can be enjoyed until the balance is consumed.

Moreover, a counter is provided in the screen and the number of balls can be known by said counter.

As described above, other embodiment of the pinball game system utilizing the communication circuit according to the present invention comprises the terminal equipment 17 comprising at least one terminal equipment, server 20 Ha provided in the pinball parlor, game machines 20b˜20e, card reader 21, and a system to play games by utilizing the Internet or the high speed communication system.

As the terminal equipment 17 used by the user to enjoy games with the game system utilizing the Internet 1 according to the present invention, it may be a cellular phone, personal computer, and television provided with personal computer functions.

### EFFECTS OF THE INVENTION

The present invention, being constituted as described above, can obtain the following effects. Firstly, even a person having trouble such as a handicapped person, an old person and the like can enjoy the game of pinball, pinball slot and the like.

Secondly, it is also possible to play games for 24 hours without being bound by the business hour.

Thirdly, settlements are made simple and easy by the prepaid card or the tied up card of the pinball and pinball slot parlors.

[Explanation of Symbols]

| | |
|---|---|
| 1 | Game system |
| 2 | Terminal equipment |
| 3 | Provider |
| 4 | Service company |
| 5 | Pinball parlor |
| 5a | Server |
| 5b | Camera |
| 5c-5f | Game machine |
| 6 | Card reader |
| 7 | Inside of pinball parlor |
| 7a | Camera |
| 8, 8a | Remote device |
| 9 | Game machine |
| 9a | Game machine |
| 10, 11 | Pinball machine |
| 10a, 11a | Game machine |
| 10b, 11b | Handle |
| 10c, 11c | Remote device |
| 10d, 11d | Camera |
| 10e, 11e | Processor |
| 11f | Light |
| 11g | Power source |
| 11h | Rotating member |
| 12 | Inside of pinball parlor |
| 12a | Camera |
| 13, 13a | Remote device |
| 14, 14a | Game machine |
| 15 | Pinball slot machine |
| 15a | Game machine |
| 15b | Slot lever |
| 15c | Button |
| 15d | Screen |
| 15e | Reel |
| 15f | Remote device |
| 15g | Sound device |
| 15h | Image device |
| 15i | Light |
| 15j | Power source |
| 16 | Game system |
| 17 | Terminal equipment |
| 18, 18a | Provider |
| 19 | Service company |
| 20 | Server |
| 20a | Pinball parlor |
| 20b-20e | Game machine |
| 20c | Game machine |
| 21 | Card reader |

What is claimed is:

1. A game system utilizing the Internet comprising a terminal equipment, at least one camera and a game machine, a server for controlling a remote device incorporating the camera, a light and a processor, and a card reader.

2. The game system utilizing the Internet according to claim 1, wherein a high speed communication system is utilized.

3. The game system utilizing the Internet according to claim 1 or 2, wherein the game machine is a pinball game machine.

4. The game system utilizing the Internet according to claim 1 or 2, wherein the game machine is a pinball slot machine.

5. A game system utilizing the Internet comprising at least one terminal equipment, a server, a game machine, and a card reader.

6. The game system utilizing the Internet according to claim 5, wherein a high speed communication system is utilized.

7. The game system utilizing the Internet according to claim 5 or 6, wherein the game machine is a pinball game machine.

8. The game system utilizing the Internet according to claim 5 or 6, wherein the game machine is a pinball slot machine.
